(19) United States
(12) Patent Application Publication
(10) Pub. No.: US 2025/0352956 A1
(43) Pub. Date: Nov. 20, 2025

(54) Highly Tuneable Graphene Oxide Membranes for Point-of-use to Portable Water Filtration

(71) Applicant: The University of Manchester, Manchester (GB)

(72) Inventors: Rahul Raveendran Nair, Manchester Lancashire (GB); Tobias Bohn, Manchester Lancashire (GB)

(21) Appl. No.: 18/874,409

(22) PCT Filed: Jul. 20, 2023
(86) PCT No.: PCT/GB2023/051915

§ 371 Date: Dec. 12, 2024

(30) Foreign Application Priority Data
Jul. 20, 2022 (GB) 2210603.3

(51) Int. Cl. B01D 71/02; B01D 71/60; C02F 1/44; C02F 103/06

(52) U.S. Cl. CPC B01D 71/0211; B01D 71/60; C02F 1/442; C02F 1/444; C02F 2103/06

(57) ABSTRACT

The present invention relates to laminate membranes for filtration of solutes. The membranes comprise graphene oxide and polyvinyl amine. The invention also relates to methods of reducing the amount of solutes in a mixture using said membranes, methods of making said membranes, and uses of said membranes.

This invention relates to laminate membranes for filtration of solutes. The membranes comprise graphene oxide and polyvinyl amine. The invention also relates to methods of reducing the amount of solutes in a mixture using said membranes, methods of making said membranes, and uses of said membranes.

### BACKGROUND

Membranes find many applications in modern industry. One such use is to remove solutes or solvents from water, e.g. to generate drinking water or to selectively separate one solute from another.

Graphene oxide (GO) membranes have been shown to provide precise control of filtration performance via a wide range of possible chemical and thermal modifications (Abolhassani et al., ACS Omega, 2, 8751-8759; Hu et al., Journal of Membrane Science, 469, 80-87). The transport and sieving properties through such membranes are governed by the path formed through random stacking of multiple layers of GO sheets and their corresponding interlayer spacing. By altering the size of the interlayer spacing, the chemical composition of the sheets and the overall transport pathway, the permeance and rejection properties of the membranes can be modified (Nair et al., Science, 335, 442-444).

Known methods of adjusting the performance of graphene oxide membranes suffer from various drawbacks, such as laborious synthesis methods, the use of toxic or expensive chemicals, and are highly specialised towards specific interlayer spacing and permeance, thereby limiting their applicability in wider membrane applications.

Accordingly, there remains a need to produce graphene oxide membranes that are highly tunable to provide precise control of the membrane structure and filtration properties.

### BRIEF SUMMARY OF THE DISCLOSURE

In a first aspect of the present invention, there is provided a laminate membrane for filtration of solutes, the membrane comprising: a plurality of graphene oxide flakes; and polyvinyl amine associated with the plurality of graphene oxide flakes.

In a second aspect of the present invention, there is provided a laminate membrane for filtration of solutes, the membrane comprising: a plurality of graphene oxide flakes; and polyvinyl amine associated with the plurality of graphene oxide flakes, wherein the membrane has a weight ratio of polyvinyl amine: graphene oxide in the range of from about 1:1 to about 1:100.

Known tunable membranes typically comprise polyethylene (PE), and are known to be highly pH and counter-ion dependent, offering precise control over their spatial conformation as well as surface charge. As a result of this, PE has the potential to directly influence the assembly process of the GO sheets (Salis et al., Chem Soc Rev, 43, 7358-7377; Dressick et al., Langmuir, 28, 15831-15843; Salomaki et al., Langmuir, 20, 3679-3683). In contrast, polyvinyl amine (PVAm) has a highly linear backbone, allowing its conformation to be adjusted from highly linear with only marginal impact on the GO assembly to highly coiled. The high primary amine group density of PVAm further offers various interaction pathways with the GO sheets, while still being water soluble.

The inventors have found that the GO laminate membranes of the invention have highly tunable rejection and permeance properties, allowing for the production of membranes with effective pore sizes across the entire ultra- and nanofiltration range. Thus, the membranes of the invention can be easily optimised towards a desired application without significant changes to the preparation process. The lack of post-treatment steps to adjust membrane performance also simplifies the scale-up process of these membranes.

Without wishing to be bound by theory, the inventors have found that altering the pH of the solution from which the membrane is produced and/or the PVAm to GO ratio of the membrane enables precise control of the molecular weight cut-off (MWCO) and pure water permeance (PWP). In particular, the membranes of the invention may be tuned so as to have a MWCO of from more than 40,000 Da down to 200 Da, with up to 10 times higher pure water permeance (PWP) than current commercial membranes at the same MWCO.

Additionally, the inventors have surprisingly found that the presence of certain species of counter anions provides additional control over the MWCO and PWP of these membranes. For example, the inventors have found that the addition of more chaotropic ions (e.g. SCN⁻ and ClO₄⁻) ions to the membranes causes a sharp decrease in the MWCO, while the addition of more kosmotropic ions (e.g. NO₃⁻ and Cl⁻) has the opposite effect and results in a sharp increase in the MWCO. In both cases, the PWP is higher than the pristine membranes, with a dramatic increase achieved with the more kosmotropic NO₃⁻ and Cl⁻. Without wishing to be bound by theory, it is thought that the presence of counter anions alters the configuration of the PVAm laminar structure of the GO to control the assembly of the graphene oxide flakes and thus the effective pore size of the membrane, as well as the interlayer spacing of the membrane.

In addition to the above, it is thought that altering the PVAm to GO ratio enables the production of membranes with desired surface charge. In particular, an excess of positively charged PVAm relative to GO may result in an overall positive surface charge.

In a third aspect of the present invention, there is provided a method of reducing the amount of one or more solutes in an aqueous mixture to produce a liquid depleted in said solutes; the method comprising:
(a) contacting a first face of a laminate membrane with the aqueous mixture comprising the one or more solutes; and
(b) recovering the liquid depleted in said solutes from or downstream from a second face of the membrane;
   wherein the laminate membrane is a membrane of the first aspect or second aspect.

In a fourth aspect of the present invention, there is provided a method of making a membrane, the method comprising stirring a mixture comprising graphene oxide and polyvinyl amine in an aqueous solution to form a membrane comprising a plurality of graphene oxide flakes and polyvinyl amine associated with the plurality of graphene oxide flakes.

In a fifth aspect of the present invention, there is provided a method of making a membrane, the method comprising stirring a mixture comprising graphene oxide and polyvinyl amine in an aqueous solution to form a membrane comprising a plurality of graphene oxide flakes and polyvinyl amine associated with the plurality of graphene oxide flakes, wherein the membrane has a weight ratio of polyvinyl amine:graphene oxide in the range of from about 1:1 to about 1:100.

In a sixth aspect of the present invention, there is provided a use of a graphene oxide laminate membrane of the first aspect or second aspect to reduce the amount of at least one solute in an aqueous solution.

### Membranes

The present invention is directed to and involves the use of graphene oxide laminate membranes. The graphene oxide laminate membranes of the invention comprise overlapped layers of substantially parallel individual graphene oxide flakes. Other than being substantially parallel, the flakes are randomly orientated. The flakes are predominantly monolayer graphene oxide. The laminate membranes of the invention have the overall shape of a sheet-like material through which liquid may pass when the laminate is wet. The laminate membrane can be used as a filtration membrane. Without wishing to be bound by theory, the liquid is not understood to pass through the flakes. It is believed that the individual flakes are stacked in such a way as to form capillary-like pathways between the faces and sides of the flakes and it is through these pathways that the liquid passes.

The graphene oxide flakes in the laminate may have the same length and width as the laminate—thus each layer of the graphene oxide laminate may comprise a single flake of graphene oxide. More usually, however, each layer of the graphene oxide laminate comprises a plurality of graphene oxide flakes

It may be that greater than 50% by weight (e.g. greater than 75% by weight, greater than 90% or greater than 98%) of the graphene oxide flakes have a diameter of less than 10 μm. It may be that greater than 50% by weight (e.g. greater than 75% by weight, greater than 90% or greater than 98%) of the graphene oxide flakes have a diameter of greater than 50 nm. It may be that greater than 50% by weight (e.g. greater than 75% by weight, greater than 90% or greater than 98%) of the graphene oxide flakes have a diameter of less than 5 μm. It may be that greater than 50% by weight (e.g. greater than 75% by weight, greater than 90% or greater than 98%) of the graphene oxide flakes have a diameter of greater than 100 nm. It may be that greater than 50% by weight (e.g. greater than 75% by weight, greater than 90% or greater than 98%) of the graphene oxide flakes have a diameter of less than 2 μm. It may be that greater than 50% by weight (e.g. greater than 75% by weight, greater than 90% or greater than 98%) of the graphene oxide flakes have a diameter of less than 1 μm. It may be that greater than 50% by weight (e.g. greater than 75% by weight, greater than 90% or greater than 98%) of the graphene oxide flakes have a diameter of less than 500 nm. It may be that greater than 50% by weight (e.g. greater than 75% by weight, greater than 90% or greater than 98%) of the graphene oxide flakes have a diameter of greater than 500 nm.

Although the flakes are predominantly monolayer graphene oxide, it is within the scope of this invention that some of the graphene oxide is present as two- or few-layer graphene oxide. Thus, it may be that at least 75% by weight of the graphene oxide is in the form of monolayer graphene oxide flakes, or it may be that at least 85% by weight of the graphene oxide is in the form of monolayer graphene oxide flakes (e.g. at least 95%, for example at least 99% by weight of the graphene oxide is in the form of monolayer graphene oxide flakes) with the remainder made up of two- or few-layer graphene oxide.

Without wishing to be bound by theory, it is believed that water, and in certain embodiments solutes, pass through capillary-like pathways formed between the graphene oxide flakes by diffusion and that the specific structure of the laminate membranes leads to the remarkable selectivity observed. The flakes in the laminate are piled on top of one another and orientated parallel to one another to form a series of layers. The flakes are arranged randomly relative to one another and typically overlap. Thus, a central portion of any one flake may be situated directly over the edge of any other flake or it may be situated directly over the central portion of any other flake. Typically, polyvinyl amine is present in the interlayer spacing formed in the laminate. The polyvinyl amine may influence the size of the interlayer spacing.

Graphene oxide flakes are two dimensional heterogeneous macromolecules containing both hydrophobic ‘graphene’ regions and hydrophilic regions with large amounts of oxygen functionality (e.g. epoxide, carboxylate groups, carbonyl groups, hydroxyl groups).

It may be that the graphene oxide flakes of which the laminate is comprised may have an oxygen: carbon weight ratio in the range of from 0.02:1.0 to 0.5:1.0. The flakes may be graphene oxide flakes, in which case the average oxygen: carbon weight ratio may be in the range of from 0.2:1.0 to 0.5:1.0, e.g. from 0.25:1.0 to 0.45:1.0. Preferably, the flakes have an average oxygen: carbon weight ratio in the range of from 0.3:1.0 to 0.4:1.0. The flakes may be partially reduced graphene oxide flakes, in which case the average oxygen: carbon weight ratio may be in the range of from 0.04:1.0 to 0.2:1.0, e.g. from 0.05:1.0 to 0.1:1.0. Graphene oxide flakes may be preferred if a higher flux is desired. Partially reduced graphene oxide flakes may be preferred if a better membrane stability is desired.

The flakes of graphene oxide which form the laminate of the invention are usually monolayer graphene oxide. However, it is possible to use flakes of graphene oxide containing from 2 to 10 atomic layers of carbon in each flake. These multilayer flakes are frequently referred to as “few-layer” flakes. Thus the laminate may be made entirely from monolayer graphene oxide flakes, from a mixture of monolayer and few-layer flakes, or from entirely few-layer flakes. Ideally, the flakes are entirely or predominantly, i.e. more than 75% w/w, monolayer graphene oxide.

The laminate membrane further comprises polyvinyl amine associated with the plurality of graphene oxide flakes. The polyvinyl amine may be associated with the plurality of graphene oxide flakes via at least one of hydrogen bonds, covalent bonds, electrostatic interactions and/or Van der Waals forces.

The polyvinyl amine may have a molecular weight of from about 10,000 Da to about 500,000 Da, from about 50,000 Da to about 500,000 Da, from about 100,000 Da to about 400,000 Da, optionally from about 320,000 Da to about 360,000 Da.

The laminate membrane may have a weight ratio of polyvinyl amine: graphene oxide in the range of from about 1:1 to about 1:100, about 1:10 to about 1:90, about 1:20 to about 1:75, or about 1:30 to about 1:50. The laminate membrane may have a weight ratio of polyvinyl amine: graphene oxide in the range of from about 1:1 to about 1:40, about 1:5 to about 1:40, about 1:10 to about 1:40, about 1:10 to about 1:30, or about 1:10 to about 1:20. It may be that laminate membrane has a weight ratio of polyvinyl amine: graphene oxide in the range of from about 1:1 to about 1:50, or about 1:5 to about 1:45. It may be that laminate membrane has a weight ratio of polyvinyl amine: graphene oxide of about 1:10, about 1:20 or about 1:40.

The laminate membrane may further comprise a plurality of anions. The laminate membrane may further comprise a plurality of chaotropic anions. The laminate membrane may further comprise a plurality of kosmotropic anions. The laminate membrane may further comprise a plurality of anions selected from: thiocyanate, chlorate, nitrate, chloride, sulfate, formate, tetraphenylborate, phosphate trioxotungsten. The plurality of anions may be thiocyanate ions. The plurality of anions may be chlorate ions. The plurality of anions may be nitrate ions. The plurality of anions may be chloride ions.

Without wishing to be bound by theory, it is thought that controlling the species and amounts of anions present in the laminate membrane allows the rejection and permeance of the membranes to be tuned.

The weight ratio of the plurality of anions to graphene oxide in the membrane may be in the range or from about 1:1 to about 600:1, from about 2:1 to about 400:1, from about 5:1 to about 100:1, or from about 8:1 to about 20:1. The weight ratio of the plurality of anions to graphene oxide may be about 10:1.

When present, the plurality of anions may be associated with the polyvinyl amine via ionic interactions.

The laminate membrane may be no more than 500 nm thick. The laminate membrane may be no more than 400 nm thick. The laminate membrane may be no more than 300 nm thick. The laminate membrane may be no more than 250 nm thick. The laminate membrane may be no more than 200 nm thick. The laminate membrane may be no more than 150 nm thick. The laminate membrane may be no more than 100 nm thick. The laminate membrane may be no more than 75 nm thick. The laminate membrane may be no more than 50 nm thick. The laminate membrane may be no more than 40 nm thick.

The laminate membrane may be no less than 10 nm thick. The laminate membrane may be no less than 15 nm thick. The laminate membrane may be no less than 20 nm thick. The laminate membrane may be no less than 25 nm thick.

The laminate membrane may be supported on a porous material. This can provide structural integrity. In other words, the graphene oxide flakes and polyvinyl amine may themselves form a layer e.g. a laminate which itself is associated with a porous support such as a porous membrane to form a further laminate structure. In this embodiment, the resulting structure is a laminate of graphene oxide and polyvinyl amine mounted on the porous support. In one illustrative example, the laminate membrane may be sandwiched between layers of a porous material.

The porous support may be an inorganic material. Thus, the porous support (e.g. membrane) may comprise a ceramic. Preferably, the support is alumina, zeolite, or silica. In one embodiment, the support is alumina. Zeolite A can also be used. Ceramic membranes have also been produced in which the active layer is amorphous titania or silica produced by a sol-gel process.

Alternatively, the support may be a polymeric material. Thus, the porous support may be a porous polymer support, e.g. a flexible porous polymer support. Preferably it is PTFE, PVDF or Cyclopore™ polycarbonate. The porous support (e.g. membrane) may comprise a polymer. The polymer may comprise a synthetic polymer. Alternatively, the polymer may comprise a natural polymer or modified natural polymer. Thus, the polymer may comprise a polymer based on cellulose.

The porous support (e.g. membrane) may comprise a carbon monolith.

The porous support layer may have a thickness of no more than a few tens of μm, and ideally is less than about 100 μm, less than about 50 μm, less than about 10 μm, or less than about 5 μm.

The thickness of the entire membrane (i.e. the laminate and the support) may be from about 1 μm to about 200 μm, e.g. from about 5 μm to about 50 μm.

The porous material should be sufficiently porous that it does not impede the passage of water but the pores should not be so small that flakes of graphene oxide and/or graphene can enter the pores.

The support may have a uniform pore-structure. Examples of porous membranes with a uniform pore structure are electrochemically manufactured alumina membranes (e.g. those with the trade names: Anopore™, Anodisc™).

Alternatively, the laminate membrane may be unsupported.

In an embodiment, the GO flakes which form the membrane have been prepared by the oxidation of natural graphite.

Methods of Reducing the Amount of One or More Solutes Using said Membranes and Uses of said Membrane in Reducing the Amount of One or More Solutes

A third aspect of the invention provides a method of reducing the amount of one or more solutes in an aqueous mixture to produce a liquid depleted in said solutes; the method comprising:
(a) contacting a first face of a laminate membrane with the aqueous mixture comprising the one or more solutes; and
(b) recovering the liquid depleted in said solutes from or downstream from a second face of the membrane;
   wherein the laminate membrane is a membrane of the first aspect or second aspect.

The method may be a method of selectively reducing the amount of a first set of one or more solutes in an aqueous mixture without significantly reducing the amount of a second set of one or more solutes in the aqueous mixture to produce a liquid depleted in said first set of solutes but not depleted in said second set of solutes.

The or each solute of the first set which are depleted in the liquid may have a molecular weight greater than a specific molecular weight exclusion limit of the laminate membrane, and the or each solute of the second set may have a molecular weight less than said specific molecular weight exclusion limit of the laminate membrane. It may be that the or each solute of the first set has a molecular weight of greater than X, wherein X is in the range of about 200 to about 40,000 Da, and the or each solute of the second set has a molecular weight less than X.

X may be in the range of about 200 Da to about 20,000 Da, about 200 Da to about 6000 Da, about 200 Da to about 3500 Da, or about 200 Da to about 2400 Da. X may be in the range of about 200 Da to about 20,000 Da, about 200 Da to about 6000 Da, or about 200 Da to about 2400 Da. X may be in the range of about 200 Da to about 3500 Da.

It may be that the method is continuous. Thus, steps a) and b) may be carried out simultaneously or substantially simultaneously. Steps a) and b) may also be carried out iteratively in a continuous process to enhance enrichment or iteratively in a batch process.

It may be that the aqueous mixture is permitted to pass through the membrane by diffusion and/or it may be that a pressure is applied.

Preferably, no electrical potential is applied across the membrane. In principle, an electrical potential could be applied to modify the transport of ions through the membrane.

The term “solute” applies to both ions and counter-ions, and to uncharged molecular species present in the solution. Once dissolved in aqueous media a salt forms a solute comprising hydrated ions and counter-ions. The uncharged molecular species can be referred to as “non-ionic species”. Examples of non-ionic species are small organic molecules such as aliphatic or aromatic hydrocarbons (e.g. toluene, benzene, hexane, etc), alcohols (e.g. methanol, ethanol, propanol, glycerol, etc), carbohydrates (e.g. sugars such as sucrose), and amino acids and peptides. The non-ionic species may or may not bind with water through hydrogen bonds. As will be readily apparent to the person skilled in the art, the term ‘solute’ does not encompass solid substances which are not dissolved in the aqueous mixture. Particulate matter will not pass through the membranes of the invention even if the particulate is comprised of ions with small radii.

The reduction of the amount one or more selected solutes in the solution which is treated with the GO membrane of the present invention may entail entire removal or each selected solute. Alternatively, the reduction may not entail complete removal of a particular solute but simply a lowering of its concentration. The reduction may result in an altered ratio of the concentration of one or more solutes relative to the concentration of one or more other solutes.

In cases in which a salt comprising one ion having a molecular weight of larger than the molecular weight exclusion limit and a counter-ion with a molecular weight below the molecular weight exclusion limit, neither ion will pass through the membrane of the invention because of the electrostatic attraction between the ions.

The precise value of the molecular weight exclusion limit for any given membrane may vary depending on application.

The method may involve a plurality of membranes. These may be arranged in parallel (to increase the flux capacity of the process/device) or in series (where a reduction in the amount of one or more solute is achieved by a single membrane but that reduction is less than desired).

The one or more solutes can be ions and/or they could be neutral organic species, e.g. sugars, hydrocarbons etc. Where the solutes are ions they may be cations and/or they may be anions.

In a sixth aspect, the invention also provides the use of a graphene oxide laminate membrane to reduce the amount of at least one solute in an aqueous solution.

Where not mutually exclusive, any of the embodiments described above in relation to the first aspect or second aspect of the invention apply equally to the third aspect of the invention.

### Methods of Making the Composite Membrane

In a fourth aspect of the invention there is provided a method of making a membrane, the method comprising depositing a mixture comprising graphene oxide and polyvinyl amine in an aqueous solution on a substrate to form a membrane comprising a plurality of graphene oxide flakes and polyvinyl amine associated with the plurality of graphene oxide flakes.

In a fifth aspect of the present invention, there is provided a method of making a membrane, the method comprising stirring a mixture comprising graphene oxide and polyvinyl amine in an aqueous solution to form a membrane comprising a plurality of graphene oxide flakes and polyvinyl amine associated with the plurality of graphene oxide flakes, wherein the membrane has a weight ratio of polyvinyl amine: graphene oxide in the range of from about 1:1 to about 1:100.

The mixture comprising graphene oxide and polyvinyl amine in an aqueous solution may be produced by adding a first aqueous dispersion comprising single layer graphene oxide flakes to a second aqueous dispersion comprising polyvinyl amine.

The first aqueous dispersion comprising single layer graphene oxide flakes may be produced by exfoliating a graphene oxide dispersion in water. It may be that some multi-layer GO sheets remain in the suspension. If this is the case, the multi-layer GO sheets may be removed by centrifugation to provide a suspension of 2D graphene oxide flakes.

The exfoliation step may be achieved by applying energy to the graphene oxide dispersion. Said energy may be sonic energy. The sonic energy may be ultrasonic energy. It may be delivered in using a bath sonicator or a tip sonicator. Alternatively the energy may be a mechanical energy, e.g. shear force energy or grinding. Preferably, however, the energy is sonic energy.

The second aqueous dispersion comprising polyvinyl amine may be prepared by dissolving polyvinyl amine in water.

The method may further comprise applying energy to the deposited mixture comprising graphene oxide and polyvinyl amine to remove any formed agglomeration. Said energy may be sonic energy. The sonic energy may be ultrasonic energy. It may be delivered in using a bath sonicator or a tip sonicator. Alternatively the energy may be a mechanical energy, e.g. shear force energy or grinding. Preferably, however, the energy is sonic energy.

The method may further comprise adding the deposited mixture comprising graphene oxide and polyvinyl amine to water and filtering the resulting suspension to form the laminate membrane. The filtering may be performed under vacuum.

The mixture comprising graphene oxide and polyvinyl amine may have a weight ratio of polyvinyl amine: graphene oxide in the range of from about 1:1 to about 1:100, about 1:10 to about 1:90, about 1:20 to about 1:75, or about 1:30 to about 1:50. The mixture comprising graphene oxide and polyvinyl amine may have a weight ratio of polyvinyl amine: graphene oxide in the range of from about 1:1 to about 1:40, about 1:5 to about 1:40, about 1:10 to about 1:40, about 1:10 to about 1:30, or about 1:10 to about 1:20. It may be that the mixture comprising graphene oxide and polyvinyl amine has a weight ratio of polyvinyl amine: graphene oxide in the range of from about 1:1 to about 1:50, or about 1:5 to about 1:45. It may be that the mixture comprising graphene oxide and polyvinyl amine has a weight ratio of polyvinyl amine: graphene oxide has a weight ratio of about 1:10, about 1:20 or about 1:40.

The pH of the mixture comprising graphene oxide and polyvinyl amine in aqueous solution may be at least about 9. The pH of the mixture comprising graphene oxide and polyvinyl amine in aqueous solution may be at least about 10. The pH of the mixture comprising graphene oxide and polyvinyl amine in aqueous solution may be no more than about 13. The pH of the mixture comprising graphene oxide and polyvinyl amine in aqueous solution may be from about 9 to about 13. The pH of the mixture comprising graphene oxide and polyvinyl amine in aqueous solution may be from about 10 to about 12.

The method may further comprise adding one or more salts to the mixture comprising graphene oxide and polyvinyl amine. The one or more salts may be chaotropic or kosmotropic. The one or more salts may be chaotropic. The one or more salts may be kosmotropic. The one or more salts may be selected from a thiocyanate, chlorate, nitrate, chloride, sulfate, formate, tetraphenylborate, or phosphate trioxotungsten salt. The salt may be a thiocyanate salt. The salt may be a chlorate salt. The salt may be a nitrate salt. The salt may be a chloride salt.

The salt may be present in a concentration of from about 1 mM to about 100 mM. The salt may be present in a concentration of from about 2 mM to about 80 mM. The salt may be present in a concentration of from about 5 mM to about 60 mM. The salt may be present in a concentration of from about 10 mM to about 50 mM. The salt may be present in a concentration of about 10 mM. The salt may be present in a concentration of about 50 mM.

The laminate membrane of the first aspect may be produced by the method of the fourth aspect.

The laminate membrane of the second aspect may be produced by the method of the fifth aspect.

The method may further comprise supporting the laminate membrane on a porous material. The mixture comprising graphene oxide and polyvinyl amine may be coated onto a porous support. This may be done by passing the mixture through the porous membrane for a predetermined period of time.

The term ‘aqueous solution’ as used to describe the fourth aspect of the invention can be understood to mean a liquid which contains water, e.g. which contains greater than 20% by volume water. The aqueous solution may contain more than 50% by volume water, e.g. more than 75% by volume water or more than 95% by volume water. The aqueous solution may be a water: ethanol solution.

The aqueous solution may also comprise solutes or suspended particles and other solvents (which may or may not be miscible with water). The aqueous solution may comprise additives which may be ionic, organic or amphiphillic. Examples of such additives include surfactants, viscosity modifiers, pH modifiers, iconicity modifiers, and dispersants.

Where not mutually exclusive, any of the embodiments described above in relation to the first, second and third aspects of the invention apply equally to the fourth aspect and fifth aspect of the invention.

### BRIEF DESCRIPTION OF THE DRAWINGS

Embodiments of the invention are further described hereinafter with reference to the accompanying drawings, in which:

FIG. 1 shows the filtration performance of the membranes of the invention in terms of the pure water permeance (PWP) and the molecular weight cut-off (MWCO). (a) Rejection properties of membranes prepared with 1:20 polyvinyl amine: graphene oxide (PVAm: GO) mass ratio at a pH of 10 as a function of the molecular weight of polyethylene glycol. Inset (left): Thickness dependency of 1:20 PVAm: GO membranes assembled at pH 10. Inset (right): Optical image of 1:20 PVAm: GO mass ratio membrane on a PES support (0.02 μm). (b) Influence of the addition of 10 mM of various anions during the assembly of 1:20 PVAm: GO membranes at a pH 10 and membrane thickness of 40 nm on the PWP and MWCO. Inset: Impact of the anion addition on the PWP and MWCO for membranes assembled at a mass ratio of 1:2 PVAM: GO at pH 12. (c) Benchmark of membranes prepared through the addition of various anions, pH and PVAm: GO mass ratios (within highlighted area) with commercially available ultra- and nanofiltration membranes. The pore size is estimated following the calculated molecular weight cut-off (in accordance with Howe and Clark, Environ Sci Technol 36, 3571-357).

FIG. 2 shows the effect of GO to PVAm ratio and ionic concentration on the membrane performance. (a) Influence of the GO to PVAm mass ratio on the rejection of various molecular weight polyethylene glycol and the corresponding pure water flux for 40 nm thick membranes assembled at pH 10. (b) Impact of the ionic concentration of Cl⁻ during the membrane assembly on the PWP and MWCO of the membrane prepared with 1:20 PVAm: GO ratio at pH 10. (c) and (d) Influence of the PVAm: GO ratio on the PWP and MWCO of membranes prepared with 50 mM Cl⁻ at pH 10 and 12, respectively.

FIG. 3 shows (a) the effect of different anions on the rejection capability of a membrane of the invention prepared at a mass ratio of 1:20 and pH 10 towards arsenic.

(b) The effect of different anions on the rejection capability of a membrane of the invention prepared at a mass ratio of 1:20 and pH 10 towards caffeine. (c) Optical image of a portable water filter provided by Icon Lifesaver. (d) Optical image of the cross-section of the PES hollow fibres module after coating with (12/Cl⁻/12.5/1:40). The scale bar corresponds to 10 mm. (e) Optical image of the cross-section of an untreated PES hollow fibre. The scale bar corresponds to 2 mm. (f) Cross-sectional SEM image of (12/Cl⁻/80/1:40) membrane on a PES hollow fibre. The scale corresponds to 200 nm. (g) Comparison of the MWCO curves for (12/Cl⁻/12.5/1:40) membranes prepared on a flat sheet membrane and a hollow fibre module with an untreated hollow fibre module. The dashed lines correspond to the best sigmoidal fit. All error bars are standard deviations obtained from separate measurements of at least three different membranes.

FIG. 4 shows a comparison of the total organic and inorganic carbon removal from Cambodian groundwater by a portable hollow fibre water filter before and after coating with (12/Cl⁻/12.5/1:40).

FIG. 5 shows (a) Long term stability measurement of the PWP of the (10/Cl⁻/40/1:20) membrane. (b) Stability of the (10/NO₃⁻/40/1:20) membrane permeance after filtration of different 0.1 M salt solutions.

FIG. 6 shows a schematic of anion dependent membrane assembly. (a), (c) and (e) show SEM images of the surface morphology of the (10/no ions/40/1:20), (10/NO₃⁻/40/1:20) and (10/SCN⁻/40/1:20) membranes respectively. The images were taken with 5 kV at 10k magnification. The length scale in the images corresponds to 5 μm. Insets (b), (d) and (f) show SEM images of GO flakes assembled on a silica wafer from the (10/no ions/40/1:20), (10/NO₃⁻/40/1:20) and (10/SCN⁻/40/1:20) solutions respectively. The scales correspond to 320, 430 and 310 nm. (g), (h) and (i) show a schematic drawing of the assembled membrane structure for the (10/no ions/40/1:20), (10/NO₃⁻/40/1:20) and (10/SCN^{-/}40/1:20) membranes respectively.

FIG. 7 shows a schematic of the conformational change of PVAm chains at pH 10 as a function of the anionic species.

FIG. 8 shows the disameter of the PVAm chains as a function of added counter-ions (10 mM) at (a) pH 10 and (b) pH 12.

FIG. 9 shows the XRD spectra of 1:20 PVAm:GO membrane as a function of added anions.

FIG. 10 shows XPS spectra of (a) (10/Cl⁻/40/1:20) membrane, and (b) (12/Cl⁻/40/1:20) membrane.

FIG. 11 shows the streaming potential measurements of pristine membranes prepared with varying ratios of PVAm: GO.

### DETAILED DESCRIPTION

The term ‘chaotropic’ refers to a species that can disrupt the hydrogen bonding network between water molecules, thus diminishing hydrophobic effects and increasing the solubility of nonpolar solvent particles. Chaotropic anions typically have an affinity towards hydrophobic surfaces, allowing them to compete with the interactions between hydrophobic solutes. Chaotropic anions typically have a large ionic radius and/or a low charge density. Examples of chaotropic anions include chlorate ions (ClO₄⁻) and thicyanate ions (SCN⁻).

The term ‘kosmotropic’ refers to a species that enhance the degree of hydrogen bonding between water molecules, thus enhancing hydrophobic effects and decreasing the solubility of nonpolar solvent particles. Kosmotropic anions typically have a small ionic radius and/or a high charge density. Examples of kosmotropic anions include chloride ions (Cl⁻) and sulfate ions (SO₄²⁻).

The graphene oxide or graphite oxide for use in this application can be made by any means known in the art. In a preferred method, graphite oxide can be prepared from graphite flakes (e.g. natural graphite flakes) by treating them with potassium permanganate and sodium nitrate in concentrated sulphuric acid. This method is called Hummers method. Another method is the Brodie method, which involves adding potassium chlorate (KClO₃) to a slurry of graphite in fuming nitric acid. For a review see, Dreyer et al. The chemistry of graphene oxide, Chem. Soc. Rev., 2010, 39, 228-240.

Individual graphene oxide (GO) sheets can then be exfoliated by dissolving graphite oxide in water or other polar solvents with the help of ultrasound, and bulk residues can then be removed by centrifugation and optionally a dialysis step to remove additional salts.

In a specific embodiment, the graphene oxide of which the graphene oxide laminates of the invention are comprised is not formed from wormlike graphite. Worm-like graphite is graphite that has been treated with concentrated sulphuric acid and hydrogen peroxide at 1000° C. to convert graphite into an expanded “worm-like” graphite. When this worm-like graphite undergoes an oxidation reaction it exhibits a higher increase the oxidation rate and efficiency (due to a higher surface area available in expanded graphite as compared to pristine graphite) and the resultant graphene oxide contains more oxygen functional groups than graphene oxide prepared from natural graphite. Laminates formed from such highly functionalized graphene oxide can be shown to have a wrinkled surface topography and lamellar structure (Sun et al,; Selective Ion Penetration of Graphene Oxide Membranes; ACS Nano 7, 428 (2013) which differs from the layered structure observed in laminates formed from graphene oxide prepared from natural graphite. Such membranes do not show fast ion permeation of small ions and a selectivity which is substantially unrelated to size (being due rather to interactions between solutes and the graphene oxide functional groups) compared to laminates formed from graphene oxide prepared from natural graphite.

The preparation of graphene oxide laminate supported on a porous membrane can be achieved using filtration, spray coating, casting, dip coating techniques, road coating, inject printing, or any other thin film coating techniques

For large scale production of supported graphene based membranes or sheets it is preferred to use spray coating, road coating or inject printing techniques. One benefit of spray coating is that spraying GO solution in water on to the porous support material at an elevated temperature produces a large uniform GO film.

Graphite oxide consists of micrometer thick stacked graphite oxide flakes (defined

by the starting graphite flakes used for oxidation, after oxidation it gets expanded due to the attached functional groups) and can be considered as a polycrystalline material. Exfoliation of graphite oxide in water into individual graphene oxide flakes is achieved by sonication followed by centrifugation at 10000 rpm to remove few layers and thick flakes. Graphene oxide laminates of the invention are formed by restacking of these single or few layer graphene oxides by a number of different techniques such as spin coating, spray coating, road coating and vacuum filtration.

Graphene oxide membranes according to the invention consist of overlapped layers of randomly oriented single layer graphene oxide sheets. Due to this difference in layered structure, the atomic structure of the capillary structure of graphene oxide membranes and graphite oxide are different. For graphene oxide membranes the edge functional groups are located over the non-functionalised regions of another graphene oxide sheet while in graphite oxide mostly edges are aligned over another graphite oxide edge. These differences unexpectedly may influence the permeability properties of graphene oxide membranes as compared to those of graphite oxide.

A layer of graphene consists of a sheet of sp²-hybridized carbon atoms. Each carbon atom is covalently bonded to three neighboring carbon atoms to form a ‘honeycomb’ network of tessellated hexagons. Carbon nanostructures which have more than 10 graphene layers (i.e. 10 atomic layers; 3.4 Å interlayer distance) generally exhibit properties more similar to graphite than to mono-layer graphene. Thus, throughout this specification, the term graphene is intended to mean a carbon nanostructure with up to 10 graphene layers. A graphene layer can be considered to be a single sheet of graphite.

In the context of this disclosure the term graphene is intended to encompass both pristine graphene (i.e. un-functionalised or substantially un-functionalised graphene) and reduced graphene oxide. When graphene oxide is reduced a graphene like substance is obtained which retains some of the oxygen functionality of the graphene oxide. It may be however that the term ‘graphene’ is excludes both graphene oxide and reduced graphene oxide and thus is limited to pristine graphene. All graphene contains some oxygen, dependent on the oxygen content of the graphite from which is it derived. It may be that the term ‘graphene’ encompasses graphene that comprises up to 10% oxygen by weight, e.g. less than 8% oxygen by weight or less than 5% oxygen by weight.

Specific preparation conditions used to prepare the membranes of the invention may be referred to in the abbreviated form (pH/anion/thickness (nm)/ratio of PVAm: GO). For example, a 40 nm thick laminate membrane having a PVAm: GO weight ratio of 1:20 and further comprising chloride anions that was prepared at a pH of 10 may be referred to as a (10/Cl⁻/40/1:20) membrane.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### Examples

The present invention relates to laminate membranes for water filtration comprising graphene oxide and polyvinyl amine. The inventors have found that found that manipulating certain conditions during membrane preparation significantly alters the permeance and rejection properties of the assembled films, namely altering pH, PVAm:GO ratio and presence of counter anions.

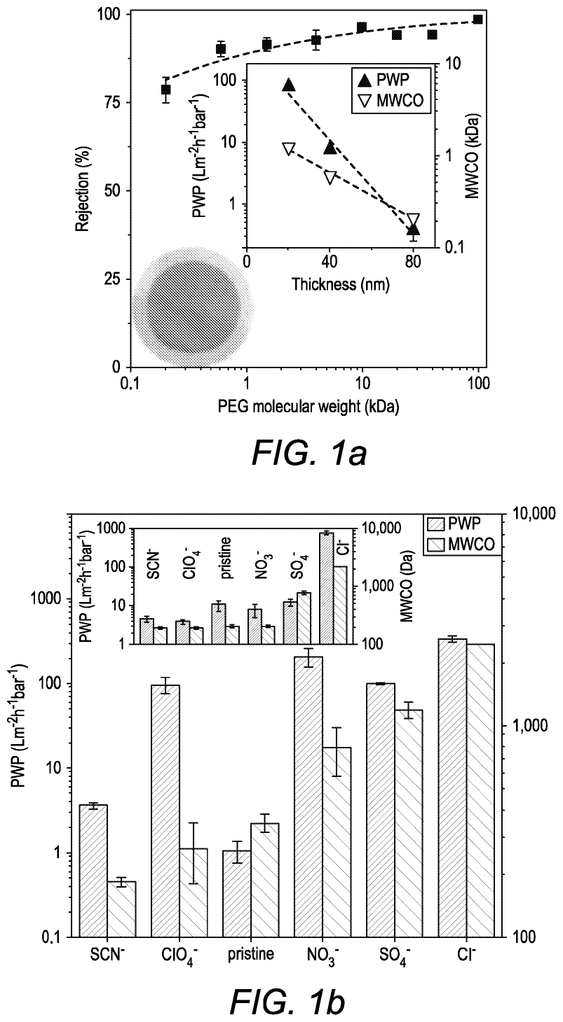

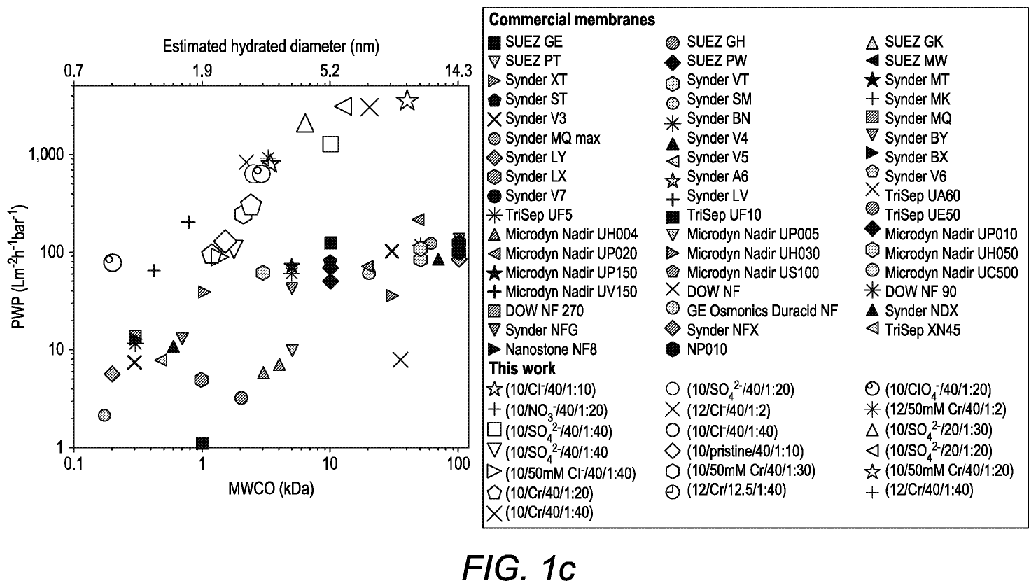

FIG. 1B shows the impact of the addition of various anions at a concentration of 10 mM during the membrane assembly on the pure water permeance (PWP) and molecular weight cut-off (MWCO). Sodium was used as the cation for all added ion pairs to isolate the impact of the anions. The addition of SCN⁻ and ClO₄⁻ significantly improves the MWCO of the prepared membrane down to nanofiltration-like levels of 200 Da, in combination with a more than 7 times improved PWP in the case of ClO₄⁻ compared to the pristine membrane. Surprisingly, the addition of NO₃⁻ and Cl⁻ has the opposite effect on the assembled membrane performance with an increase in the MWCO up to ˜780 Da and ˜2400 Da, corresponding to lose nanofiltration or tight ultrafiltration membranes, in addition a drastic improvement in the PWP up to ˜200 and 330 Lm⁻²h⁻¹bar⁻¹.

FIG. 1B inset shows the anion dependency of membranes prepared at a mass ratio of 1:2 and pH 12. While only a weak dependency of the performance is visible for most anions, the addition of Cl⁻ drastically improves the permeance to an ultrarapid 800 Lm⁻²h⁻¹bar⁻¹ in combination with a relatively low MWCO of only around 2200 Da, corresponding to a tight ultrafiltration membrane.

FIG. 1C shows a performance comparison of the membranes of the invention with commercial ultra- and nanofiltration membranes. The different preparation conditions are subsequently abbreviated as (pH/anion/thickness (nm)/ratio of PVAm:GO). By optimising the preparation conditions, the inventors have found that tight nanofiltration membranes can be prepared with a MWCO of around 190 Da and a PWP of ˜78 Lm⁻²h⁻¹bar⁻¹ (10/ClO₄⁻/40/1:20), improving the permeance more than 7 times over commercial membranes while maintaining rejection performance. In the range of looser nanofiltration membranes with a MWCO in the range of 800 Da, the membrane of the present invention (10/NO₃⁻/40/1:20) further surpasses the flux of current state of the art membranes by more than 5 times, demonstrating very competitive performance across the entire nanofiltration range. The inventors could further imitate the wide range of MWCO available in current ultrafiltration membranes with a more than 166-, 32- and 16-times improved flux at a cut-off in the range of 2000, 6000 and 40,000 Da for the (12/Cl⁻/40/1:40), (10/SO₄²⁻/20/1:30) and (10/Cl⁻/40/1:10) membranes respectively. Such vast improvements in the flux over most of the nano- and ultrafiltration range offers a huge potential to reduce the energy demand of such filtrations, as well as a possible reduction of the required membrane area and herewith connected waste and manufacturing cost.

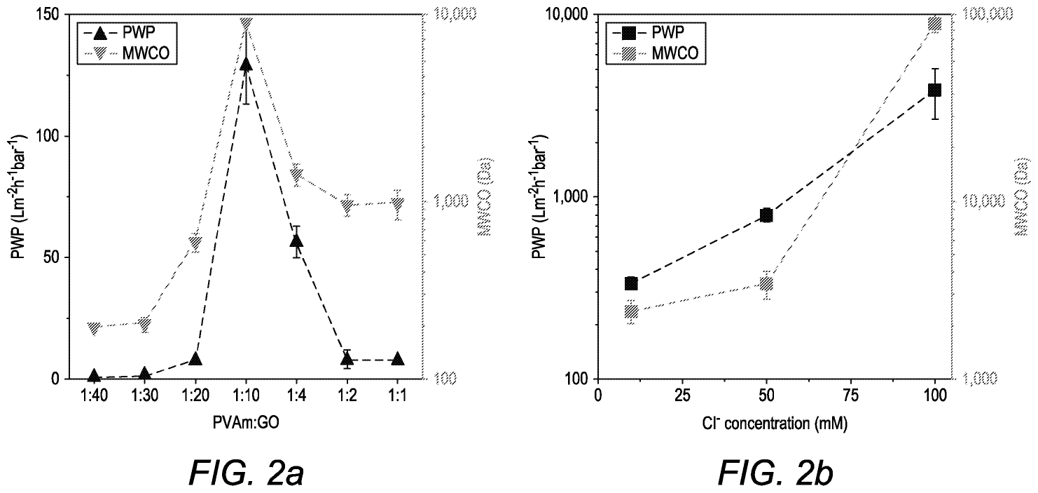

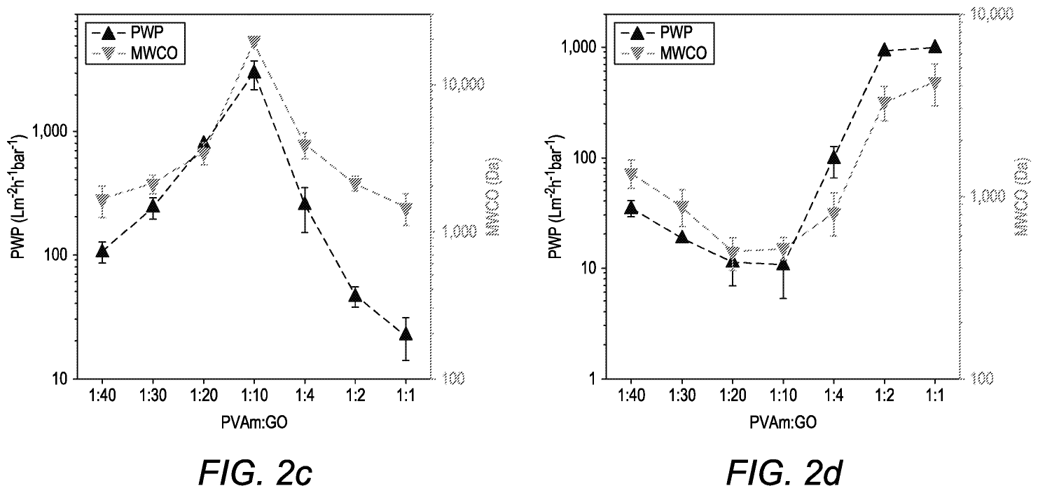

FIG. 2B further shows the impact of the different concentrations of Cl anions on the membrane performance, indicating more drastic improvement in the PWP up to an ultrafast 800 Lm⁻²h⁻¹bar⁻¹, with only a moderate increase in the MWCO up to ˜3400 Da at a concentration of 50 mM, thus making this membrane it a promising candidate for ultrafiltration applications. Higher concentrations reduced the stability of the prepared solutions and very high MWCO of more than 98,000 Da were obtained for 100 mM Cl⁻. Furthermore, in the presence of anions, the concentration of PVAm drastically affects the membrane performance (as indicated in FIG. 2C) for the addition of 50 mM Cl⁻. The PWP and MWCO increase exponentially with increasing PVAm content up to ultrahigh ˜2990 L⁻²h⁻¹bar⁻¹ and a ˜20,000 Da for a ratio of 1:10, with any further increase in the PE content decreasing the PWP and MWCO again. This membrane performance can further be tuned through an adjustment of the pH during the assembly.

Thus, the inventors have devised a novel methodology to prepare GO based membranes with desired performance, namely surface charge, MWCO and PWP, based on simple changes of the pH, salt and polymer content during the assembly.

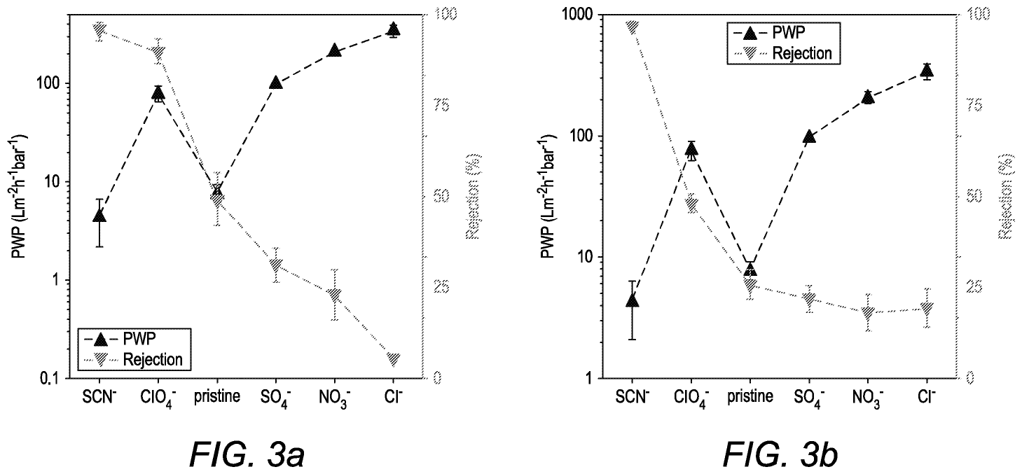

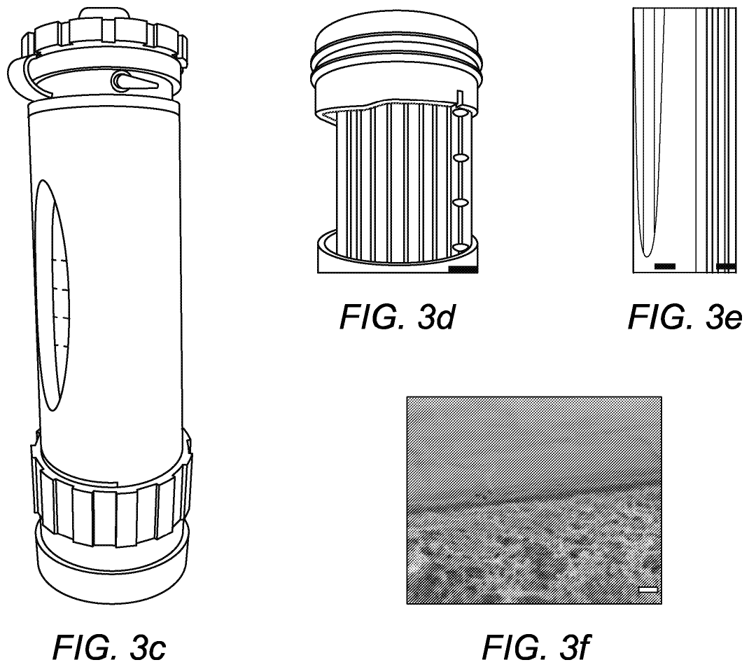

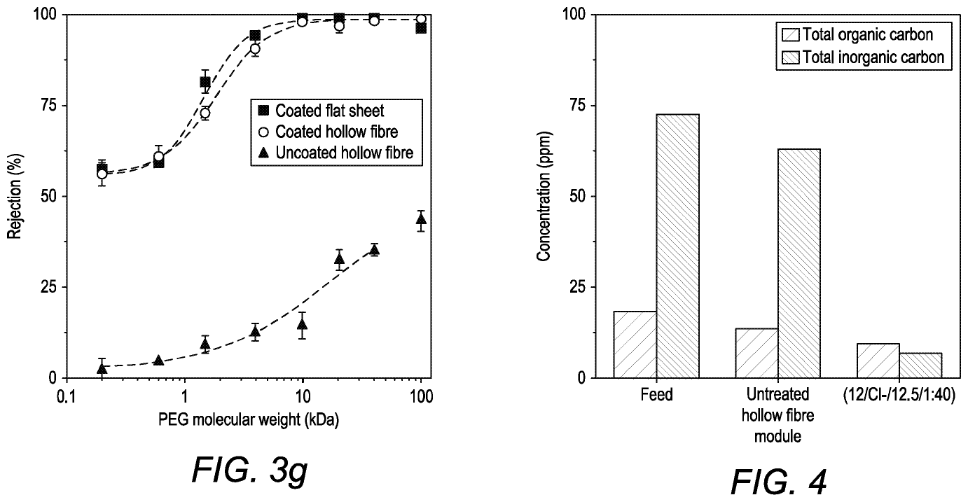

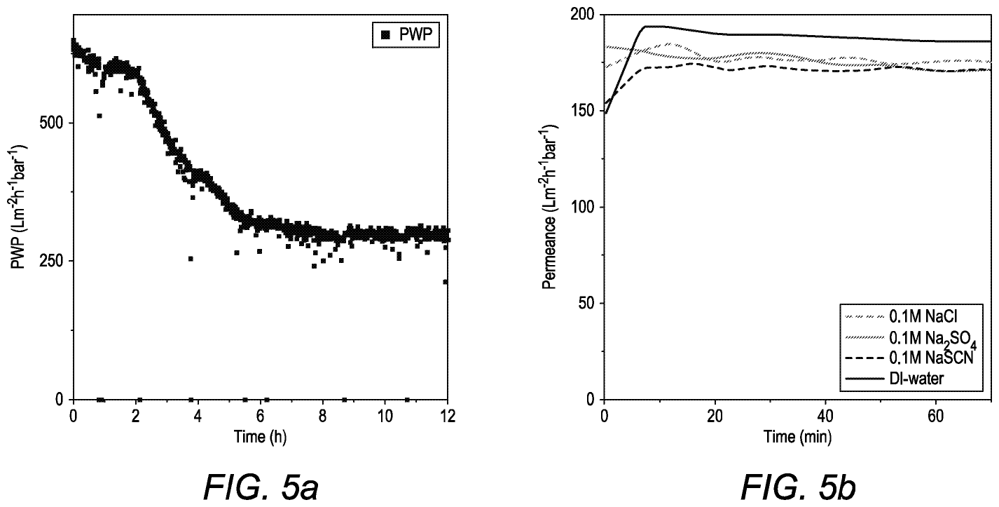

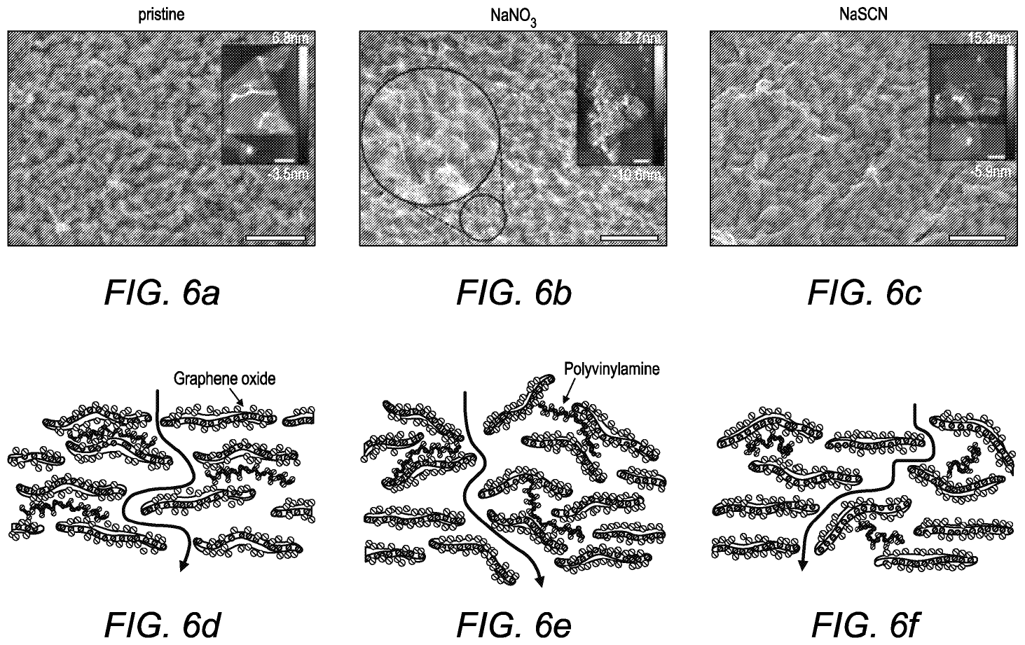

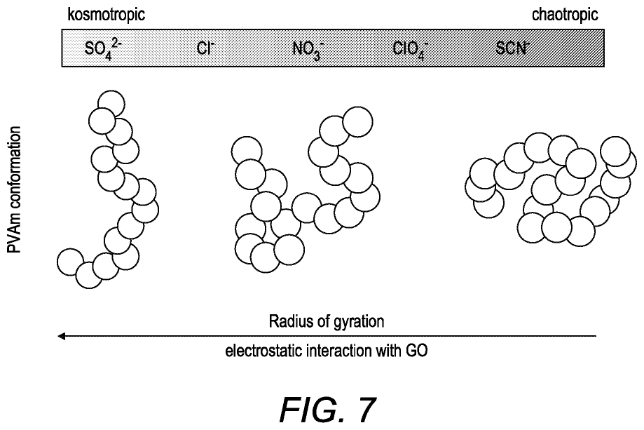

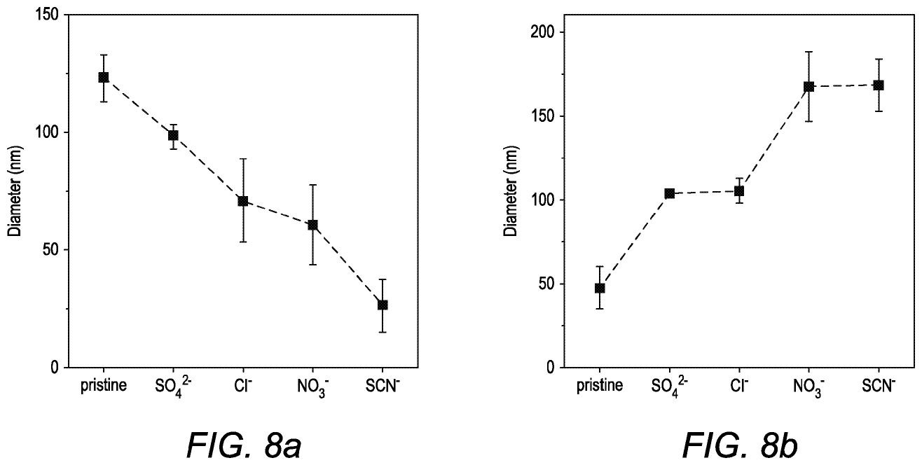

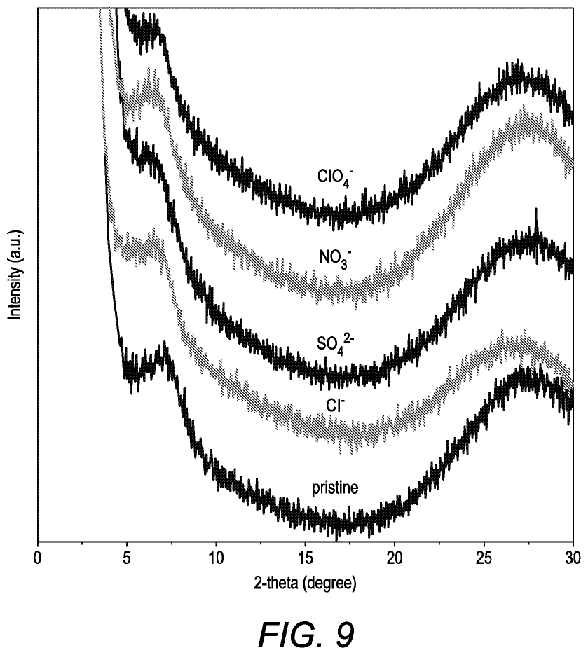

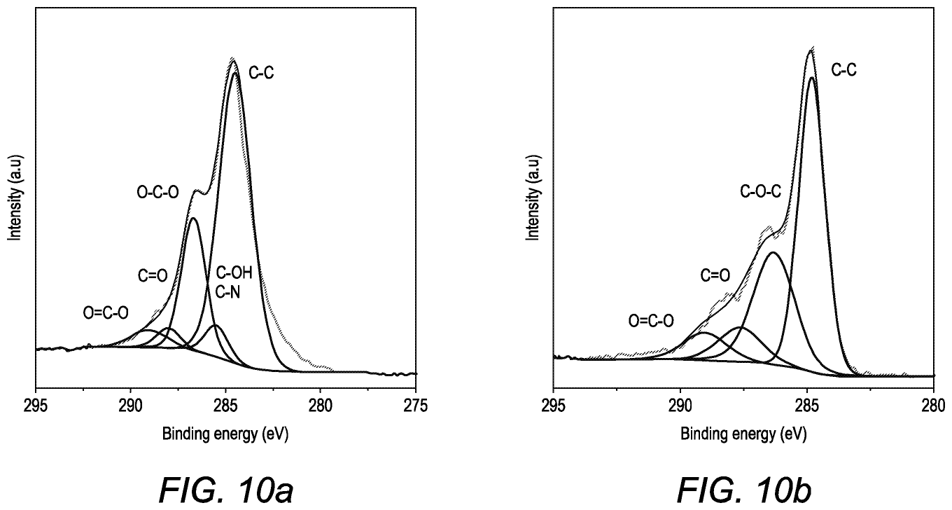

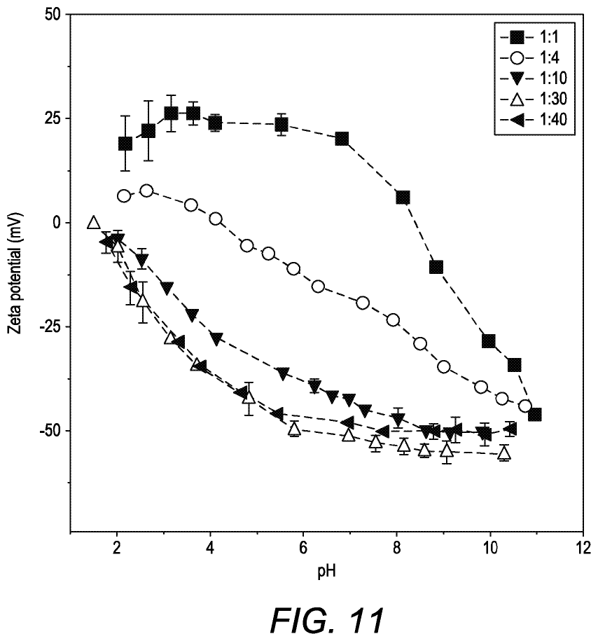

To evaluate the potential of the present membranes towards the removal of real contaminants, filtration experiments were performed with arsenic and caffeine molecules as representatives for the commonly found heavy metal and pharmaceutical contaminations in drinking water sources. FIG. 3A shows the arsenic removal efficiency of the membranes of the invention prepared at a mass ratio of 1:20, pH 10 and including various anions. In agreement with the MWCO data, relatively low rejection rates were obtained for most membranes, however the removal efficiency drastically increased to more than 95 and 89% through the addition of SCN and ClO₄⁻ during the assembly respectively. Such rejection rates are in line with current state of the art nanofiltration membranes, while drastically improving PWP by more than 7 times. Similarly, the addition of SCN⁻ and ClO₄⁻ during membrane preparation drastically improves the rejection of caffeine to up to 97% for SCN⁻, surpassing the removal rates possible with current nanofiltration membranes (FIG. 3B).

FIG. 5A shows the PWP of a (10/Cl⁻/40/1:20) membrane of the invention during long-time filtration experiments, indicating a stable permeance over several hours once a steady state is reached. ICP-OES measurements did not indicate any Na⁺ leakage from the membrane once the steady state was reached. We further investigated the possibility to exchange performance of an already assembled membrane by filtration of 0.1 M solutions of NaCl, Na₂SO₄ and NaSCN through a (10/NO₃⁻/40/1:20) membrane and measurement of the subsequent PWP (FIG. 5B). The permeance only marginally decreases after filtration of the salt solutions with no visible difference in the measured PWP for the three salt solutions, further confirming the stability of our assembled membranes.

We further assessed the scalability of our membranes by preparing a (12/Cl⁻/12.5/1:40) coating on the lumen side of a tubular PES hollow fibre module (provided by Icon Lifesaver) consisting of 47 tubular hollow fibre membranes with a total membrane area of more than 1000 cm². FIG. 3D shows an optical image of the cross-section of such a module after this coating, indicating the highly uniform nature of said coating even when preparing such thin film on large quantities of fibres simultaneously. In contrast, FIG. 3E shows an optical image of the cross-section of an equivalent PES hollow fibre module that was not treated with the coating. The corresponding molecular weight dependent rejection curves further demonstrate almost identical performance between membranes assembled on a flat sheet or in a hollow fibre module (FIG. 3G). The high quality of such assembled films is further confirmed by FEG-SEM images of such a coating with 80 nm thickness on a hollow fibre FIG. 3F.

To evaluate the potential of a portable water filter, the efficiency in reducing the total carbon content of real groundwater obtained from Cambodia was investigated (FIG. 4). Despite its high permeance of around 600 Lm⁻²h⁻¹bar⁻¹, the hollow fibre module coated with the (12/Cl⁻/12.5/1:40) coating can drastically reduce the inorganic and organic carbon content, whereas almost no change was visible for the untreated water filter.

To further understand the origin of the anion dependent performance, the surface morphology of membranes assembled with a mass ratio of 1:20 and various anions was studied under a scanning-electron microscope (SEM) (FIG. 6A, C, E). The addition of NO₃⁻ drastically changes the morphology of the assembled films from relatively flat, as in the case of sheets prepared without additional anions, to highly wrinkled (FIG. 6C inset). In contrast, the addition of SCN⁻ only marginally changes the morphology of the assembled sheets compared to the case without any anions. A similar trend can further be obtained following AFM images on GO sheets assembled from solutions with different ion content (FIG. 6B, D, F). The bilayer morphology is highly wrinkled when NO₃⁻ anions are added to the solution, whereas the addition of SCN⁻ resembles the anion free case. Thus, the anion and pH induced change of the apparent pore size of the membranes can be understood considering the impact of the PVAm chain on the stacking of the GO sheets as schematically displayed in FIG. 6G, H, I. Depending on the number of protonated amines on the PVAm backbone and the interaction with the solvent, the confirmation of these attached chains can range from rod like, as expected for the partially charged PE at pH 10, to coiled for the mostly neutrally charged PVAm at pH 12.

Without wishing to be bound by theory, it is thought that increasingly chaotropic anions induce an increasing collapse of polyamine chains, due to their more effective neutralisation of the protonated amine groups, while the opposite trend has been observed for neutral PE chains and correlates to the increased non-electrostatic adsorption of the chaotropic anions (FIG. 7). The intermolecular origin may be attributed to differences in hydration strength/hydration entropy of kosmo- and chaotropic anions, differences in their polarizability and their effect on the surrounding water structure. The added anions can thus qualitatively be ordered by their chaotropic tendency following the lyotropic series which can be expressed as SO₄²⁻<Cl⁻<NO₃⁻<ClO₄⁻<SCN⁻ (Salis A. & Ninham, B. W., Chem Soc Rev 43, 7358-7377).

Dynamic light scattering (DLS) measurements of the confirmational diameter of the PVAm under different pH and ion content correlated well with this proposed trend (FIG. 8). Whereas the low signal-to-noise ratio of the membranes during XRD measurements further confirms their reduced laminar structure (FIG. 9).

Without wishing to be bound by theory, the stacking of the GO sheets will only be marginally affected by the presence of relatively linear PVAm chains as through the addition of highly kosmotropic or highly chaotropic anions at pH 10 or 12 respectively. Similarly, GO sheets assembled with relatively neutral PVAm chains (highly chaotropic anions at pH 10 and highly kosmotropic anions at pH 12) can be expected to form laminar films based on the high flexibility of the polyelectrolyte chains and low extent of electrostatic interactions with GO. The expected small interlayer spacing and ordered laminar structure for such assembled membranes correlates well with the measured pore size typically attributed to nanofiltration membranes. It is thus thought that the lower MWCO of the membranes prepared with the highly chaotropic ClO₄⁻ and SCN⁻ compared to the pristine case at pH 10 is related to the improved flexibility of the PVAm chains. It also thought that the presence of such chaotropic anions leads to a reduced interaction between the GO and the PVAm chains. Furthermore, without wishing to be bound by theory, it is thought that anions belonging to neither extreme (such as Cl⁻ and NO₃⁻) result in partially contracted and elongated PVAm chain segments while still possessing a high degree of interaction with the GO sheets. This thus limits the self-assembly properties of the GO sheets and results in the highly wrinkled morphology visible in FIGS. 6C and 6D, which, in combination with the probable misalignments of the interlayer structure, increases the effective pore size and decreases the effective permeation length.

Without wishing to be bound by theory, the lower sensitivity of the membranes prepared at pH 12 towards changes in the PVAm content is attributed to the lower degree of interaction between the PVAm chains and the GO sheets, due to the PVAm being neutral at pH 12. Large amount of PVAm chains is required before the increased transport resistance caused by their presence in the interlayer gallery is surpassed by the shortening of the effective permeation length caused by the disordered membrane structure. The opposite trend at pH 10 is likely related to an overcompensation of the GO surface charge by an excess of positively charged PVAm chains, and thus gives rise to improved laminar assembly in addition to the transport resistance caused by the intercalated chains.

XPS C1s spectra of the 1:20 membrane prepared at pH 10 and 12 further indicate differences in the composition of the functional groups (FIG. 10). It is thought that these slight changes in the chemical composition may also contribute to the observed differences in performance.

In conclusion, we show that simple changes in the solution pH, ionic content and PVAm to GO mass ratio during the membrane assembly can be used to precisely tune the rejection and permeance of the resulting membranes. This allows for the production of membranes with pore sizes across almost the entire ultra- and nanofiltration range, while surpassing the flux of current commercial membranes by more than 5 times. This methodology does not require any additional post-treatment steps to adjust the membrane performance, which significantly simplifies the scale-up process of such membranes. Tuning of the PVAm to GO ratio further opens up the possibility to create membranes with desired surface charge which, in combination with the precise control over the permeance and rejection, facilitates the preparation of highly optimised membranes for a variety of applications such as heavy metal removal, water softening or as an RO pre-filter.

### Materials and Methods

### GO/PVAm Membrane Preparation

Graphene oxide dispersions were prepared by dissolving 50 g of a 10 mg/ml GO dispersion (William-Blythe) in 150 ml of deionised water followed by a 2 h bath sonication at 180 W. The subsequent dispersion was centrifugated 2 times at 7000 rpm to remove any remaining multi-layered GO sheets. Polyvinyl amine was obtained in the form of the commercial Lupamin®9095 solution (BASF) containing a high content of ammonium format as a by-product from the synthesis process (Tong et al., Reactive and Functional Polymers 86, 111-116). The PVAm was precipitated by dissolving 50 g in a 150 ml of a 1:6 volume ratio water: ethanol solution, redispersion in 50 ml of DI-water and dialysis (MWCO 10,000 Da) for two days. PVAm stock solution were subsequently prepared by adding a specified amount of the purified PVAm to 50 ml of pH adjusted DI-water and carefully added to 150 ml of a 0.05 ml/ml pH adjusted GO dispersion under vigorous stirring. The corresponding GO/PVAm dispersion was bath sonicated at 60 W for 1 h to re-disperse any formed agglomeration and desired amounts of salts added if required. This solution is left for at least one day before further usage. Around 40 nm thick GO/PVAm membranes were prepared by adding 1.38 μl of the corresponding dispersion to 200 ml of pH adjusted DI-water and vacuum filtration through a 30 nm polythersulfone (Sterlitech).

Depending on the desired mass ratio of PVAm to GO, the appropriate amount of PVAm stock solution was added to 50 ml of pH adjusted DI-water relative to a total GO amount of 10 mg. The PVAm solution was then carefully added to 150 ml of the prepared GO dispersion under vigorous stirring throughout 2 h. The corresponding GO/PVAm dispersion was bath sonicated at 60 W (Fisherbrand FB15050) for 30 min to re-disperse any formed agglomeration and desired amounts of salts added if required. This solution is left for at least one day before further usage. The membranes were prepared on top of a 47 mm diameter PES membrane (Sterlitech) with an average pore size of 30 nm in a vacuum assembly (Sigma) by filling the upper funnel with 200 ml of pH adjusted DI-water and addition of appropriate amounts of the GO/PVAm dispersion. The membrane thickness was estimated based on the assumption that only GO is present in the used dispersion as

$$ t = \frac{c * V * 4}{π * {d}^{2} * ρ}$$

where c corresponds to the concentration of GO in the used GO/PVAm solution, V to the volume of the GO/PVAm solution added, d to the available membrane diameter during the assembly, and ρ to the density of GO, respectively. A GO concentration of 0.05 mg mL⁻¹ was assumed for all used GO/PVAm solutions and a GO density of 1.7 g cm⁻³.

The used hollow fibre modules were carefully rinsed with DI-water before their use and subsequently coated with polydopamine (PDA) by flowing a 50 mM acetate buffer solution (pH 5) containing 2 gL⁻¹ dopamine hydrochloride and 20 mM NalO₄ through the lumen of the membrane modules for 30 min with a peristaltic pump (Krossflow research ii) at 45 mL min⁻¹. The fibres were then thoroughly washed with DI-water until the pH was neutral again. Such prepared hollow fibre modules were then coated by adding appropriate amounts of the prepared GO/PVAm dispersion to 1 L of pH adjusted DI-water and filtration of this dispersion through the membrane in a dead-end mode at a constant flow rate of 10 mL min⁻¹. Once only around 10% of the feed solution was left, a vacuum was applied to the permeate side (PC 3001 Vario) with 500 mbar. The peristaltic pump was then turned off after around 1 h, and the vacuum pump was left running for an additional 4 h before it was turned off and the modules removed. Lastly, the permeate side of the coated membrane modules was filled with a 30 w % glycerol/water solution for around 30 min before it was removed, and the module was left for drying in an oven at 40° C. for 2 days.

### Pressure Filtration Experiments

All pressure filtration measurements were carried out using a HP 4750 high

pressure stirred cell (Sterlitech) connected to a nitrogen cylinder and the permeate volume monitored with a scale (Ohaus Scout). Every measurement was repeated with at least three different membranes to ensure the reproducibility of the results. The pure water permeance was evaluated by measuring the permeate volume of DI-water over time under an applied pressure of 50 psi and calculated as

$$PWP = \frac{Δ {w}_{p}}{{A}_{m} \times \text{?} t \times p}$$

$$\text{?} \text{indicates text missing or illegible when filed}$$

where Δwₚ corresponds to the weight change in the permeate solution during the measurement interval Δt, Aₘ the membrane area and p to the applied pressure. All such measurements were conducted at a steady state.

To probe the molecular weight dependent sieving properties of our membranes we used a solution containing 1 g/L of polyethylene glycol (PEG) with a molecular weight of 200, 600, 1 500, 4 000, 10 000, 20 000, 40 000 and 100 000 Da respectively. A stirring rate of 400 rpm was used during the filtration to avoid excessive fouling of the membrane and every measurement repeated for at least three times. The concentration of the different PEGs was evaluated using a high-performance liquid chromatography (HPLC) with an evaporative light scattering detector (ELSD) as detailed below. The pollutant rejection was calculated as R=100*(1−cₚ/c_{F}), where cₚ and c_{F} corresponds to the concentration in the permeate and retentate, respectively. The molecular weight cut off of our membranes was determined based on fitting the molecular weight dependent rejection data to a sigmoidal curve and calculation of the molecular weight corresponding to 90% rejection (Rohani et al., Journal of Membrane Science, 382, 278-290). Removal of common pollutants in drinking water was evaluated using solutions containing 20 ppm and 50 ppm of potassium arsenate and caffeine, respectively. At least 50 ml were filtrated by before any measurements was taken to avoid the influence of adsorption. The concentration of arsenic was evaluated with inductively coupled plasma mass spectroscopy (ICP-MS), whereas the caffeine rejection was determined with through HPLC with ultraviolet-visible (UV-VIS) adsorption as detailed below. The pollutant rejection was calculated as R=100* (1−cₚ/c_{F}), where cₚ and c_{F} corresponds to the concentration in the permeate and retentate, respectively.

### HPLC-ELSD

The concentration of PEG was evaluated through light scattering measurements of an Agilent 1260 infinity II ELSD detector with the used parameter detailed in Table 1 below. We used an Agilent 1260 infinity II liquid chromatography system and a reverse phase 5 μm zorbax C8 column (150×4.6 mm) to separate the different molecular weight PEG molecules before measuring their individual concentration in the ELSD detector. A gradient method using HPLC grade water and HPLC grade acetonitrile was used for the separation as detailed in Table 2.

TABLE 1

| Parameter | Value | |
|---|---|---|
| Flow rate | 0.1 | ml/min |
| Column | 30° | C. |
| Temperature | | |
| Injection volume | 50 | μL |
| ELSD evaporator | 90° | C. |
| ELSD nebulizer | 85° | C. |
| Gas flow rate | 1.4 | SLM |

TABLE 2

| Time | Acetonitrile content in % |
|---|---|
| 0 | 15 |
| 5 | 35 |
| 5.1 | 46 |
| 8 | 46 |
| 8.1 | 48 |
| 11 | 50 |
| 11.1 | 51 |
| 14 | 53 |
| 14.1 | 75 |
| 15 | 75 |
| 20.1 | 90 |
| 25 | 90 |
| 25.1 | 15 |
| 35 | 15 |

### HPLC-UV/VIS

The concentration of caffeine was evaluated by measuring the adsorption at 275nm using the Agilent 1290 infinity II UV/VIS detector attached to the aforementioned HPLC system and column. An isocratic method consisting of 60 v % water and 40 v % acetonitrile is used to elute the molecule from the column.

### Membrane Characterisation

The stacking of the GO/PVAm sheets as a function of the added anions was measured with a Bruker fastscan atomic force microscope in tapping mode for sheets assembled on a silica wafer from a droplet of a 100 times diluted solution. Membrane morphology was further evaluated with a Zeiss ultra-55 field emission gun scanning electron microscope (FEG-SEM) for 40 nm thick membranes on a PES flat sheet membrane. The cross-section of such coatings on PES hollow fibres was evaluated for slightly higher membrane thicknesses of around 80 nm to due resolution of the system.

The X-ray diffraction spectra of our membrane was evaluated in the range of 3° to 30° for 2-theta (step size of 0.02° and recording rate of 0.2 s) using the Bruker D8 with a Cu K═ (λ=1.5406 Å). 500 nm thick membranes prepared on anodisc alumina filter (0.2 μm pore size Merck) were used for the measurements as the intercalation of polyelectrolyte drastically reduces the signal to noise ratio. The ESCA2SR X-ray photoelectron spectrometer (Scienta Omicron GmbH) was used for the XPS analysis with monochromatic Al Kα radition (15 kV bias at 300 W, 20 mA emission) and the survey spectra measured with a pass energy of 80 eV and core levels with a pass energy of 20 eV. A low-energy electron flood gun was used to neutralise the chagrining effects on insulating samples. Charge referencing was conducted using the adventitious C1s peak at 284.8 eV. The obtained spectra were deconvoluted using the CASAXPS software and a Shirley-type background. The C1s spectra is deconvoluted into C—C (284.7 eV), C—O (286.5 eV), O—C—O (286 eV), C═O (287.3 eV) and OH—C═O (288.7 eV) to estimate the types of chemical bonds present. The Anton Par Surpass 3 was used to determine the influence of the PVAm content on the surface charge of our membranes across a pH range from 2 to 11 and a mixture of 5 mM NaCl and KCl as the electrolyte, respectively.

1. A laminate membrane for filtration of solutes, the membrane comprising:
a plurality of graphene oxide flakes; and
polyvinyl amine associated with the plurality of graphene oxide flakes, wherein the membrane has a weight ratio of polyvinyl amine: graphene oxide in the range of from about 1:1 to about 1:100.

2. The membrane of claim 1, wherein the graphene oxide flakes of which the laminate is comprised have an average oxygen: carbon weight ratio in the range of from 0.2:1.0 to 0.5:1.0, optionally in the range of from 0.3:1.0 to 0.4:1.0.

3. The membrane of claim 1, further comprising a plurality of anions selected from: thiocyanate, chlorate, nitrate, chloride, sulfate, formate, tetraphenylborate, phosphate trioxotungsten.

4. The membrane of claim 3, wherein the plurality of anions are thiocyanate ions.

5. The membrane of claim 3, wherein the plurality of anions are chlorate ions.

6. The membrane of claim 3, wherein the plurality of anions are nitrate ions.

7. The membrane of claim 3, wherein the plurality of anions are chloride ions.

8. The membrane of claim 3, wherein the weight ratio of the plurality of anions to graphene oxide in the membrane is in the range or from about 10:1 to about 600:1.

9. The membrane of claim 1, wherein the membrane has a weight ratio of polyvinyl amine: graphene oxide in the range of from about 1:1 to about 1:50, optionally in the range of from about 1:10 to about 1:40.

10. The membrane of claim 1, wherein the membrane is no more than 500 nm thick.

11. The membrane of claim 1, wherein the membrane is no less than 10 nm thick.

12. A method of reducing the amount of one or more solutes in an aqueous mixture to produce a liquid depleted in said solutes; the method comprising:
(a) contacting a first face of a laminate membrane with the aqueous mixture comprising the one or more solutes; and
(b) recovering the liquid depleted in said solutes from or downstream from a second face of the membrane;
wherein the laminate membrane is a membrane of claim 1.

13. The method of claim 12, wherein the method is a method of selectively reducing the amount of a first set of one or more solutes in an aqueous mixture without significantly reducing the amount of a second set of one or more solutes in the aqueous mixture to produce a liquid depleted in said first set of solutes but not depleted in said second set of solutes.

14. The method of claim 13, wherein each solute of the first set has a molecular weight of greater than X, wherein X is in the range of about 200 to about 40,000 Da, and the or each solute of the second set has a molecular weight less than X.

15. A method of making a membrane, the method comprising depositing a mixture comprising graphene oxide and polyvinyl amine in an aqueous solution on a substrate to form a membrane comprising a plurality of graphene oxide flakes and polyvinyl amine associated with the plurality of graphene oxide flakes, wherein the membrane has a weight ratio of polyvinyl amine: graphene oxide in the range of from about 1:1 to about 1:100.

16. The method of claim 15, wherein the pH of the aqueous solution is at least about 10.

17. The method of claim 16, wherein the pH of the aqueous solution is from about 10 to about 12.

18. The method of claim 15, wherein the mixture further comprises a thiocyanate, chlorate, nitrate or chloride salt.

19. The method of claim 18, wherein the salt is present in a concentration of from about 10 mM to about 100 mM, optionally in a concentration of about 50 mM.

20. A laminate membrane for filtration of solutes, the membrane comprising: a plurality of graphene oxide flakes; and polyvinyl amine associated with the plurality of graphene oxide flakes, wherein the membrane has a weight ratio of polyvinyl amine: graphene oxide in the range of from about 1:1 to about 1:100, wherein the membrane is produced according to a method of claim 15.

21. Use of a graphene oxide laminate membrane of claim 1 to reduce the amount of at least one solute in an aqueous solution.
